(19) United States
(12) Patent Application Publication
(10) Pub. No.: US 2019/0119964 A1
(43) Pub. Date: Apr. 25, 2019

(54) LATCH MECHANISM FOR FOLDING DOOR OR WINDOWS

(71) Applicants: Paul Hau, Watertown, WI (US); Matthew Thomas Taylor, Milton, WI (US)

(72) Inventors: Paul Hau, Watertown, WI (US); Matthew Thomas Taylor, Milton, WI (US)

(73) Assignee: HOPPE Holding AG, Mustair (CH)

(21) Appl. No.: 16/169,538

(22) Filed: Oct. 24, 2018

Related U.S. Application Data
(60) Provisional application No. 62/577,063, filed on Oct. 25, 2017.

(51) Int. Cl. E05C 9/18; E05F 15/624; E06B 9/06; E06B 3/48

(52) U.S. Cl. CPC E05C 9/1858; E05F 15/624; E05Y 2900/132; E06B 3/481; E05Y 2900/148; E06B 9/0638

(57) ABSTRACT

A multi-panel door or window apparatus is provided. The apparatus has at least first and second panels that are foldable relative to one another. An automatic latch arrangement is provided that automatically actuates a shootbolt to engage a track of the apparatus as the first and second panels transition towards a co-planar relationship. Methods of latching the apparatus are provided as well. The automatic latch arrangement independent of the door or window apparatus is also provided.

### CROSS-REFERENCE TO RELATED PATENT APPLICATION

This patent application claims the benefit of U.S. Provisional Patent Application No. 62/577,063, filed Oct. 25, 2017, the entire teachings and disclosure of which are incorporated herein by reference thereto.

### FIELD OF THE INVENTION

This invention generally relates to latch systems for doors or windows that have multiple panels.

### BACKGROUND OF THE INVENTION

Doors or windows separate two separate spaces from one another. This may be two separate spaced within a building or a space within a building and an exterior space. Depending on the location of the doors and the spaces that are separated, it may be desirable to have doors or windows that close off an opening between the adjacent spaces that is large or expansive as compared to a standard door or window.

For example, there has been a movement towards eliminating the distinction between exterior living spaces and interior living spaces. Large doors or windows allow for removing this distinction, when desired, but also allowing for closing the opening between the interior space and the exterior space when the weather becomes less desirable.

Due to the large expanse that the doors or windows are required to close, it is often impractical to provide one or two panels that close off the entire opening. As such, doors or windows for these types of openings will often include a plurality of folding panels that fold onto one another when it is desired to open the door and substantially remove the barrier between the two adjacent spaces and that are unfolded when it is desired to separate the two spaces.

The present invention relates to improvements in latch systems for securing the panels of the panels of doors or windows in a closed state (e.g. typically in a coplanar stated).

### BRIEF SUMMARY OF THE INVENTION

In an embodiment, a door or window apparatus including a first track, a first panel, a second panel, a mounting arrangement and an automatic latch arrangement is provided. The first track has a longitudinal first groove extending lengthwise along a longitudinal axis. The first panel has spaced apart first and second sides. The second panel has spaced apart third and fourth sides. The second side hingedly attaches to the third side. The first and second panels pivot between a first orientation in which the first and second panels are coplanar and parallel to the longitudinal axis and a second orientation in which the first and second panels are folded relative to one another and are non-parallel to the longitudinal axis. The mounting arrangement pivotably secures the first and fourth sides adjacent the longitudinal axis. The mounting arrangement includes a first guide mounted adjacent one of the first and fourth sides slidably guided by the first track to allow the first and fourth sides to move relative to one another along the longitudinal axis. The automatic latch arrangement mounts to the first panel proximate the second side. The automatic latch arrangement includes a first shootbolt and an actuation arrangement. The first shootbolt selectably retracts and extends relative to the first panel between an extended state and a retracted state. The first shootbolt operably extends into the first track in the extended state when the first and second panels are in the first orientation. The first shootbolt thereby prevents the first and second panels from pivoting from the first orientation. The actuation arrangement includes a biasing mechanism, an engagement catch, and a contact. The biasing mechanism is operably coupled to the first shootbolt biasing the shootbolt from the retracted state toward the extended state. The engagement catch actuates between an engaged state and a released state. In the engaged state, the engagement catch operably engages the shootbolt when the shootbolt is in the retracted state to hold the shootbolt in the retracted state. In the released state, the engagement catch operably disengages from the shootbolt allowing the biasing mechanism to drive the shootbolt from the retracted state to the extended state. The contact is operably coupled to the engagement catch. The contact engages with the second panel as the first and second panels transition to the first orientation from the second orientation to drive the engagement catch from the engaged state to the released state.

In one embodiment, the contact and second panel are configured such that the engagement catch will be driven into the released state only when the shootbolt is overlapped at least in part with the first track.

In one embodiment, the first guide slides, at least in part, within the first groove. The contact and second panel are configured such that the engagement catch will be driven into the released state only when at least a portion of the shootbolt has traveled completely past the first groove as the first and second panels are transitioning from the second orientation to the first orientation.

In one embodiment, the track has opposed walls with the first groove formed between the opposed walls. The contact and second panel are configured such that the engagement catch will be driven into the released state only when the shootbolt will not extend between the opposed walls.

In one embodiment, the second and third sides move transverse to the longitudinal axis as the first and fourth sides move toward or away from one another along the longitudinal axis.

In one embodiment, a handle is operably coupled to the shootbolt. The handle has a released state and an engaged state. The handle is manually actuatable from the engaged state to the released state to transition the shootbolt from the extended state to the retracted state.

In one embodiment, the actuation arrangement includes a pivoting linkage pivoting about a pivot axis. The contact is connected to the pivoting linkage proximate a first end of the pivoting linkage. The engagement catch is connected to the pivoting linkage proximate a second end opposite the first end with the pivot axis being positioned between the first and second ends.

In one embodiment, the contact is adjustably mounted to the pivoting linkage to adjust a position at which the contact will engage the second panel as the first and second panels transition towards the first orientation from the second orientation.

In one embodiment, the contact is threadably mounted to the pivoting linkage.

In one embodiment, the actuation arrangement includes a second biasing mechanism acting on the engagement catch biasing the engagement catch from the released state towards the engaged state. The second panel acts against the second biasing mechanism when driving the engagement catch from the engaged state to the released state.

In one embodiment, the automatic latch arrangement is configured such that as the first and second panels transition from the second orientation to the first orientation the shootbolt will not be driven from the retracted state to the extended state within the first groove.

In one embodiment, the biasing mechanism is a compressed gas cylinder.

In one embodiment, the track includes a second groove that is positioned adjacent to and parallel with the first groove. A longitudinal wall of the first track separates the first groove from the second groove. The shootbolt extends into the second groove in the extended state.

In one embodiment, the contact and second panel are configured such that the engagement catch will be driven into the released state only when the shootbolt is overlapped at least in part with the second groove of the first track.

In one embodiment, a linkage is connected between the biasing mechanism and the shootbolt. The engagement catch directly engages the linkage to operably engage the shootbolt in the engaged state.

In one embodiment, the first side is pivotally secured by the mounting arrangement at a fixed location along the longitudinal axis and the first guide is attached to the second panel adjacent the fourth side.

In one embodiment, a third panel having spaced apart fifth and sixth sides is provided. The fifth side hingedly attaches to the fourth side of the second panel. A fourth panel having spaced apart seventh and eighth sides is provided. The eighth side pivotally attaches to the mounting arrangement at a fixed location along the longitudinal axis. A latch arrangement between the third and fourth panels selectively secures the third and fourth panels in a coplanar orientation when the first, second, third and fourth panels are in a coplanar orientation with the sixth and seventh sides adjacent one another.

In one embodiment, the first panel includes a first vertical member. The automatic latch arrangement is mounted in the first vertical member. The first vertical member has an inner surface facing the first side of the first panel and an outer surface facing away from the first side of the first panel and providing the second side of the first panel. The contact extends through the outer surface of the first vertical member. The handle may, but need not, extend through the inner surface of the first vertical member.

In one embodiment, a second automatic latch arrangement is mounted to the second panel proximate the third side. The second automatic latch arrangement is identical to the automatic latch arrangement mounted to the first panel but has a contact that cooperates with second side of the first panel.

In one embodiment, the shootbolt travels past the first groove as the first and second panels transition from the second orientation to the first orientation. The contact and second panel are configured such that the engagement catch will be driven into the released state only when the shootbolt is sufficiently past the first groove such that the shootbolt will not be driven into the first groove.

Embodiments include methods of latching a door or window apparatus according to embodiments outlined above. Some methods include transitioning the first and second panels from the second orientation to the first orientation; preventing pivoting of the first and second panels from the first orientation to the second orientation by extending the shootbolt to the extended state into the first track, wherein extending the shootbolt includes: driving the shootbolt to the extended state with the biasing mechanism, which includes: actuating the engagement catch from the engaged state to the a released state by engaging the contact with the second panel as the first and second panels transition to the first orientation.

In one method, actuating the engagement catch occurs when the shootbolt is overlapped at least in part with the first track.

In one method, actuating the engagement catch occurs after at least a portion of the shootbolt has traveled completely past the first groove as the first and second panels are transitioning from the second orientation to the first orientation.

In one method, the door or window apparatus further includes a handle operably coupled to the shootbolt. The handle has a released state and an engaged state. The method further includes transitioning shootbolt from the extended state to the retracted state by actuating the handle from the engaged state to the released state.

In one method, the method includes adjusting a position of the contact relative to the first panel so as to adjust the relative position of the first and second panels when the second panel and the contact will engage as the first and second panels transition towards the first orientation from the second orientation.

In one method, the track includes a second groove that is positioned adjacent to and parallel with the first groove. A longitudinal wall of the first track separates the first groove from the second groove. The step of driving the shoot bolt includes extending the shootbolt into the second groove in the extended state.

In one method, the contact and second panel are configured such that the engagement catch will be driven into the released state only when the shootbolt is overlapped at least in part with the second groove of the first track.

In one method, the shootbolt travels past the first groove as the first and second panels transition from the second orientation to the first orientation. The contact and second panel are configured such that the engagement catch will be driven into the released state only when the shootbolt is sufficiently past the first groove that the shootbolt will not be driven into the first groove.

In a further embodiment, only the automatic latch arrangement is provided separate and independent from the door or window apparatus.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a folding door assembly including a plurality of panels;

FIG. 2 is a partial cross-sectional illustration of the frame of the folding door assembly of FIG. 1;

FIG. 3 is a partial illustration of several of the panels of the folding door assembly of FIG. 1 illustrating the guide members that support two of the panels;

FIG. 4 is a simplified illustration of one of the panels of the folding door assembly illustrating a part of the automatic latch assembly attached to the panel;

FIGS. 5-12 are partial illustrations of the automatic latch assembly; and

FIG. 13 is a further cross-sectional illustration of the door assembly of FIG. 1.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

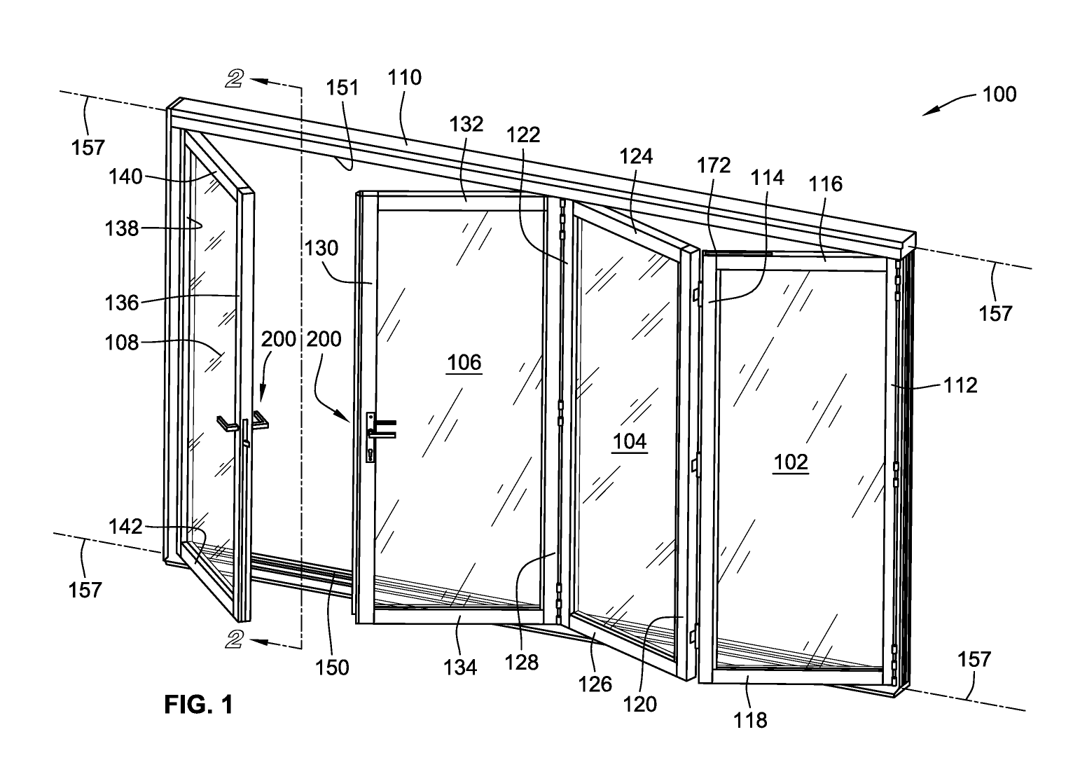

FIG. 1 illustrates a folding door assembly 100 that includes a plurality of panels including first, second, third and fourth panels 102, 104, 106, 108. While the illustrated panels 102, 104, 106, 108 are used to form a folding door assembly, the invention also includes folding window assemblies. As such, the use of panel herein shall be broad enough to cover both door panels and window panels. The invention will be described with reference to the folding door assembly 100, but the descriptions thereof are substantially equally applicable to window systems. The panels 102, 104, 106,108 are operably mounted for pivoting action to a door frame 110 that defines an opening therethrough. The first, second, third and fourth panels 102, 104, 106, 108 are operably transitionable between an open state (illustrated in part in FIG. 1) and a closed state where all four panels 102, 104, 106, 108 are generally co-planar. While four panels are illustrated, more or less panels could be included. However, embodiments of the invention will typically use at least two panels.

The first panel 102 has spaced apart first and second sides provided by first and second stiles 112, 114 as well as top and bottom sides provided by first and second rails 116, 118. The second panel 104 has spaced apart third and fourth sides provided by third and fourth stiles 120, 122 as well as top and bottom sides provided by third and fourth rails 124, 126. The third panel 106 has spaced apart fifth and sixth sides provided by fifth and sixth stiles 128, 130 as well as top and bottom sides provided by fifth and sixth rails 128, 130. The fourth panel 108 has spaced apart seventh and eighth sides provided by seventh and eighth stiles 136, 138 as well as top and bottom sides provided by seventh and eighth rails 140, 142. It is noted that terms such as first-eighth are used simply for identifying purposes and do not connote an actual number of components present. E.g. the fourth panel does not have eight stiles. The stiles may be generically referred to as vertical members. Similar vertical members of a window may also be provided when the system is a window assembly rather than a door assembly.

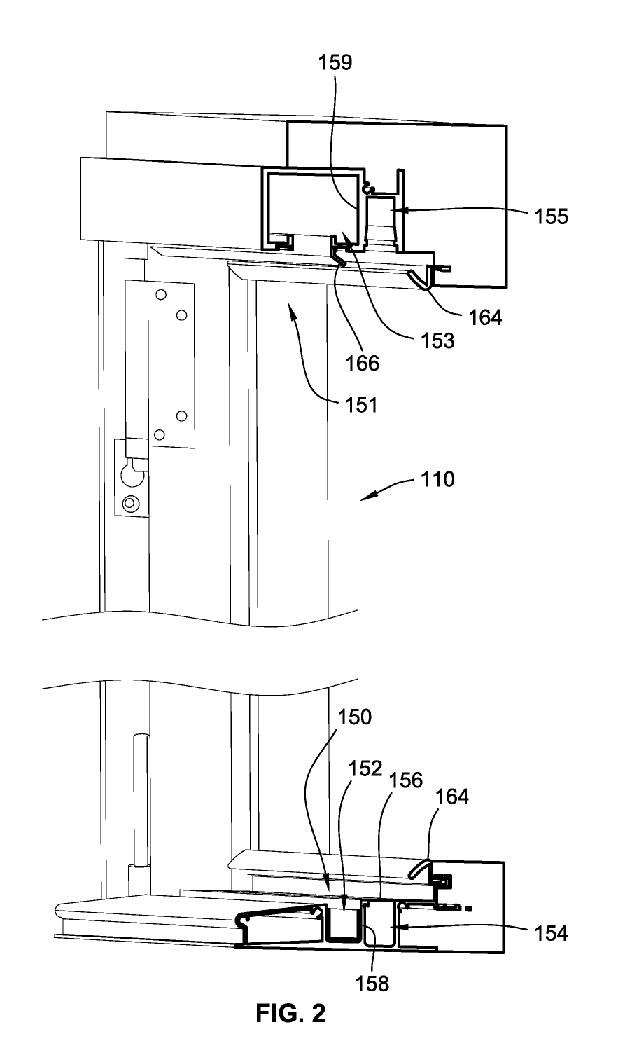

With reference to FIGS. 1 and 2, the frame 110 includes a first track 150 and a second track 151. Each track 150, 151 defines a corresponding longitudinal first groove 152, 153. Each track 150, 151 also defines a corresponding longitudinal second groove 154, 155. In the illustrated embodiment, the first track 150 forms the bottom of the opening defined by the frame 110. The second groove 154 is thus covered by one more cover members 156 to prevent debris from being trapped therein. No cover is provided in first groove 152 as it carries a guide member as will be described below.

The grooves 152-155 are generally parallel to a longitudinal axis 157 (see FIG. 1). Grooves 152, 154 of the first track 150 are separated by a longitudinally extending wall 158. Grooves 153, 155 of the second track 151 are separated by longitudinally extending wall 159. Notably, grooves 153, 155 are positioned outward from grooves 152, 154, e.g. they are positioned closer to the exterior of the door assembly while grooves 152, 154 are positioned closer to the interior of the door assembly.

Each of the panels 102, 104, 106, 108 is hingedly attached to the frame 110 on one side proximate the first and second tracks 150, 151. More particularly, the first panel 102 is hingedly attached to the frame 110 proximate first stile 112. The second panel 104 is hingedly attached to the frame 110 proximate fourth stile 122. The third panel 106 is hingedly attached to the frame 110 proximate fifth stile 128. The fourth panel 108 is hingedly attached to the frame 110 proximate eighth stile 138. Notably, the hinged connections of the first and fourth panels 102, 108 are at fixed axial locations along longitudinal axis 157. However, the hinged connections of the second and third panels 104, 106 is also slidable along the longitudinal axis 157.

The first and second panels 102, 104 are hingedly attached to one another proximate second and third stiles 114, 120 by a hinge arrangement (e.g. one or more hinges connected therebetween). The second and third panels 104, 106 are hingedly attached to one another proximate fourth and fifth stiles 122, 128 by a hinge arrangement (e.g. one or more hinges connected therebetween). This arrangement allows the panels to be folded back onto one another in a stacked orientation.

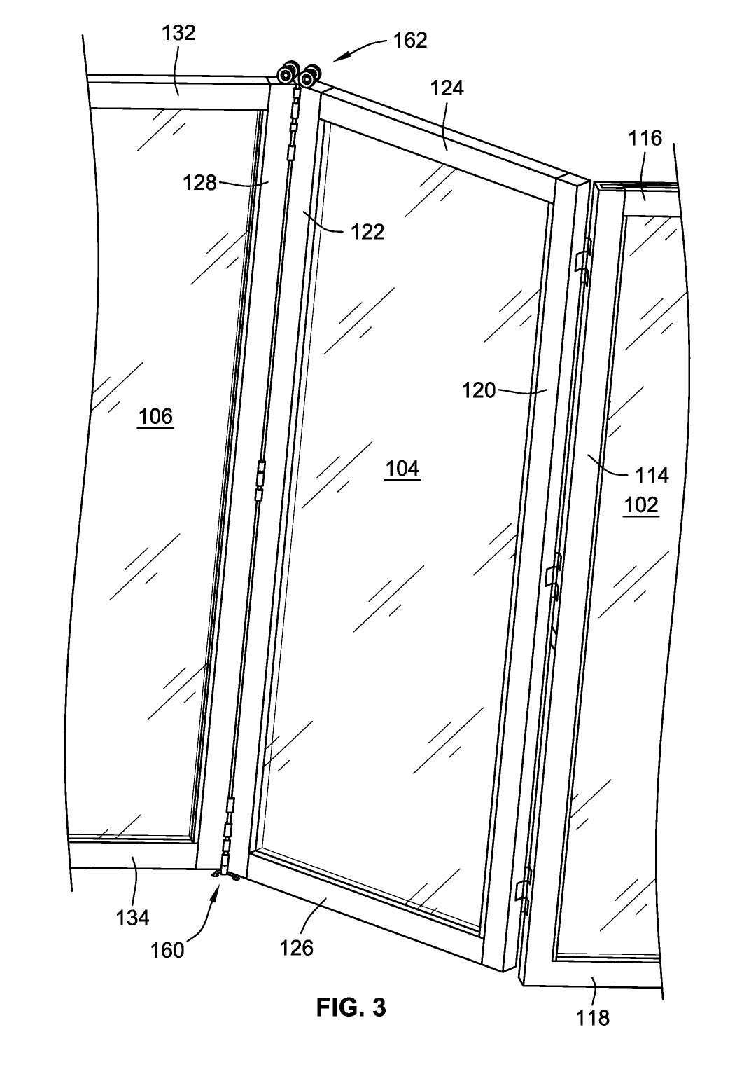

With additional reference to FIG. 3, a pair of guide members 160, 162 are operably attached to the second and third panels 104, 106 proximate fourth and fifth stiles 122, 128. These guide members 160, 162 are in the form of sets of rollers. Guide member 160 cooperates with first track 150 and rides within first groove 152 while guide member 162 cooperates with second track 151 and rides within first groove 153. By riding within grooves 152, 153, guide members 160, 162 provide lateral stability relative to longitudinal axis 157 and prevent lateral movement (e.g. perpendicular movement) relative thereto while allowing for longitudinal movement parallel to the longitudinal axis 157. In this embodiment, guide member 162 also provides vertical hanging support of the second and third panels 104, 106 proximate stiles 122, 128. By providing a hanging arrangement, there is less risk of debris inhibiting the motion of the guide member that provides the vertical support of the panels.

With reference to FIG. 2, various weather stripping components, such as weather stripping 164, 166 are also supported by frame 110. Weather stripping 164 abuts the exterior surface of each panel 102, 104, 106, 108 to help weather proof the door assembly 100.

The first, second and third panels 102, 104, 106 may be folded onto one another in a stacked orientation to provide an expansive opening between two separate spaces. This may occur, for example, between an interior space such as living room and an exterior space such as a deck or patio. The panels 102, 104, 106 are only illustrated partially folded in FIG. 1. Further, the panels 102, 104, 106, 108 may be oriented substantially co-planar with one another when it is desired to close the door assembly 100. The closed orientation may be referred to as a first orientation and the open/folded orientation may be referred to as a second orientation. In the first orientation, the co-planar panels 102, 104, 106 are also parallel to the longitudinal axis 157 while in the second orientation, the panels 102, 104, 106 are generally non-parallel to the longitudinal axis and may be perpendicular to the longitudinal axis 157.

The guide members 160, 162 and lateral movement allowed thereby permits the fourth and fifth stiles 122, 128 to move toward and away from the first stile 112 (e.g. relative to one another) when the door assembly 100 transitions between the first and second orientations. More particularly, the fourth and fifth stiles 122, 128 move toward the first stile 112 when transitioning from the first orientation toward the second orientation and away from one another when transitioning from the second orientation toward the first orientation.

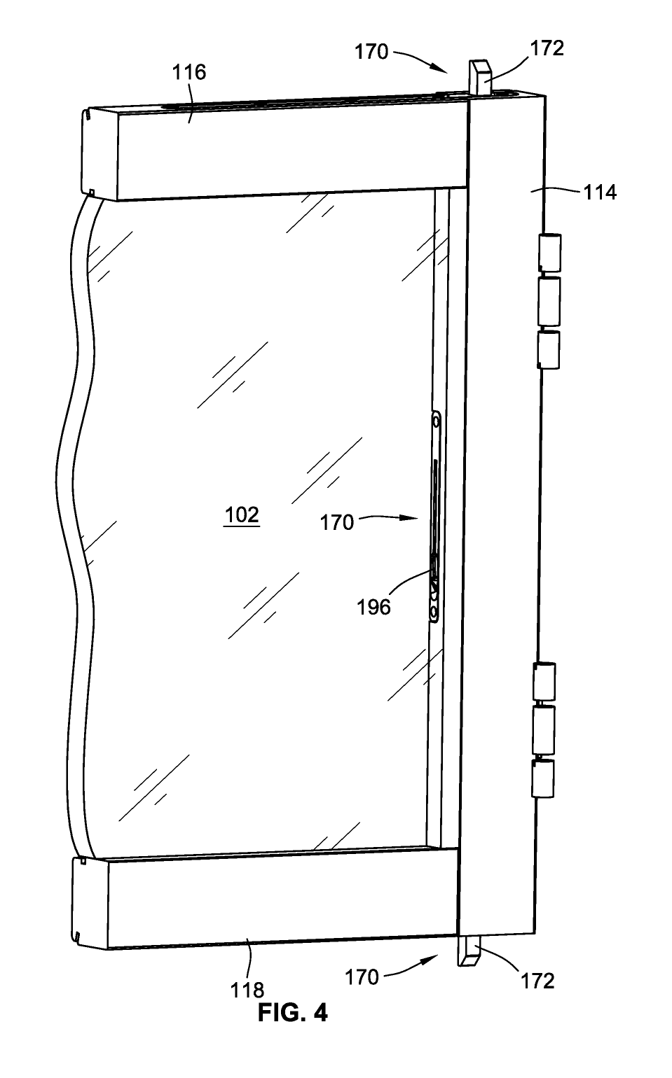

With additional reference to FIG. 4, which is a simplified illustration of first panel 102, the first panel 102 carries a first automatic latch arrangement 170 to selectively fix the lateral position of the second stile 114 and third stile 120 relative to the frame 110 and longitudinal axis 157. More particularly, when in a latched state, the automatic latch arrangement 170 operably engages frame 110 and prevents the first panel 102 and second panel 104 from folding relative to one another about the hinged connection therebetween. The automatic latch arrangement 170 includes shootbolts 172 that will engage tracks 150, 151.

FIG. 4 illustrates the automatic latch arrangement 170 in a latched state (absent tracks 150, 151) with shootbolts 172 in an extended state. This would occur when, for example, the first and second panels 102, 104 are desired to remain in a coplanar orientation (e.g. the first orientation). In the extended state, the shootbolts 172 will engage corresponding tracks 150, 151 to prevent lateral movement (e.g. perpendicular movement relative to axis 157) of the second and third stiles 114, 120.

FIG. 1 illustrates the automatic latch arrangement 170 in an unlatched state with the shootbolts 172 in a retracted state. This would occur when, for example, the first and second panels 102, 104 are desired to be folded relative to one another (e.g. the second orientation). In the retracted state, the shootbolts 172 will not engage corresponding tracks 150, 151 to allow lateral movement of the second and third stiles 114, 120.

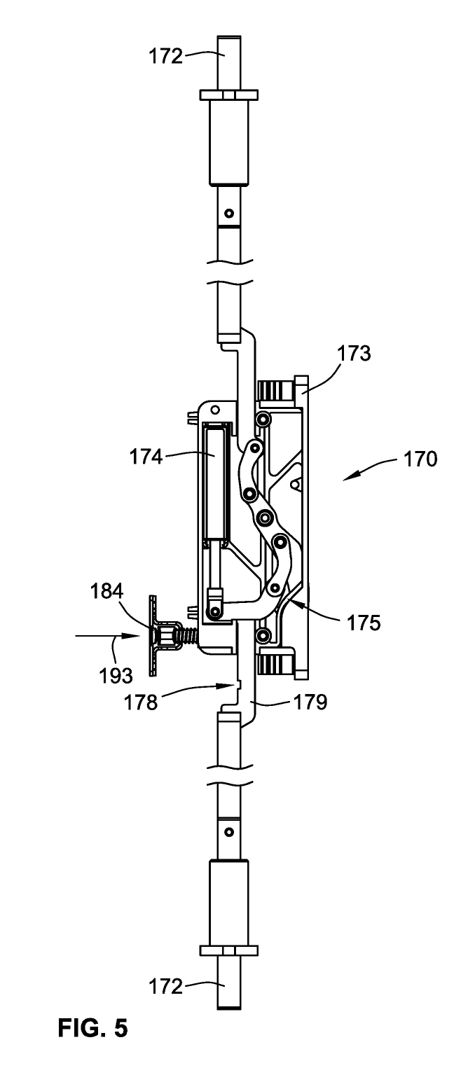

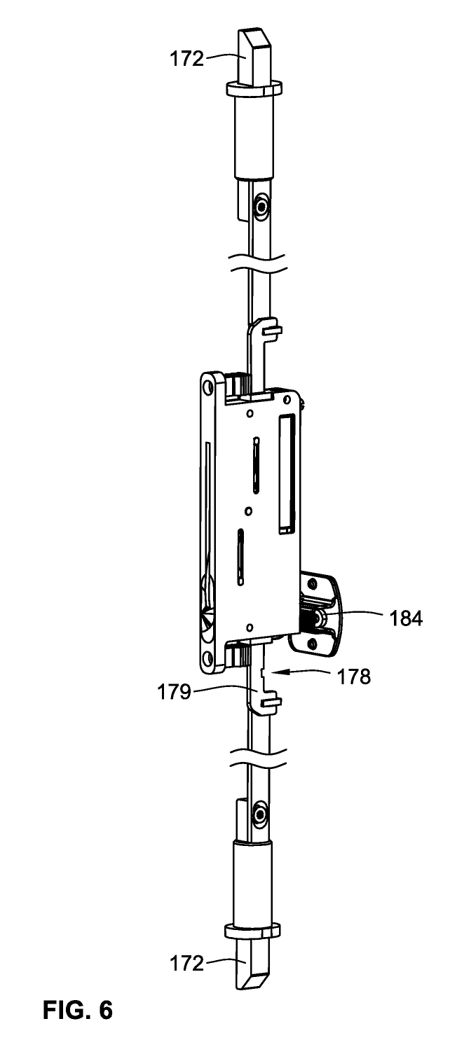

FIGS. 5-7 illustrate the automatic latch arrangement 170 removed from second stile 114 in simplified form and in and illustrated in the latched state. FIGS. 5-8 may have differing level of detail or orientation.

In addition to shootbolts 172, which only one of which may be included in alternative embodiments, the automatic latch arrangement 170 includes a casing 173 (see e.g. FIGS. 5 and 4) mountable within the stile (e.g. stile 114) of a panel.

An actuation arrangement allows for selectively and, preferably, automatically actuating the shootbolts from the retracted state to the extended stated. The actuation arrangement includes a biasing mechanism in the form of a compressed gas cylinder 174 that is operably coupled to the shootbolts 172 by a linkage 175 to bias the shootbolts 172 towards the extended state. In alternative embodiments, the biasing mechanism may be in the form of a spring, e.g. a coil spring.

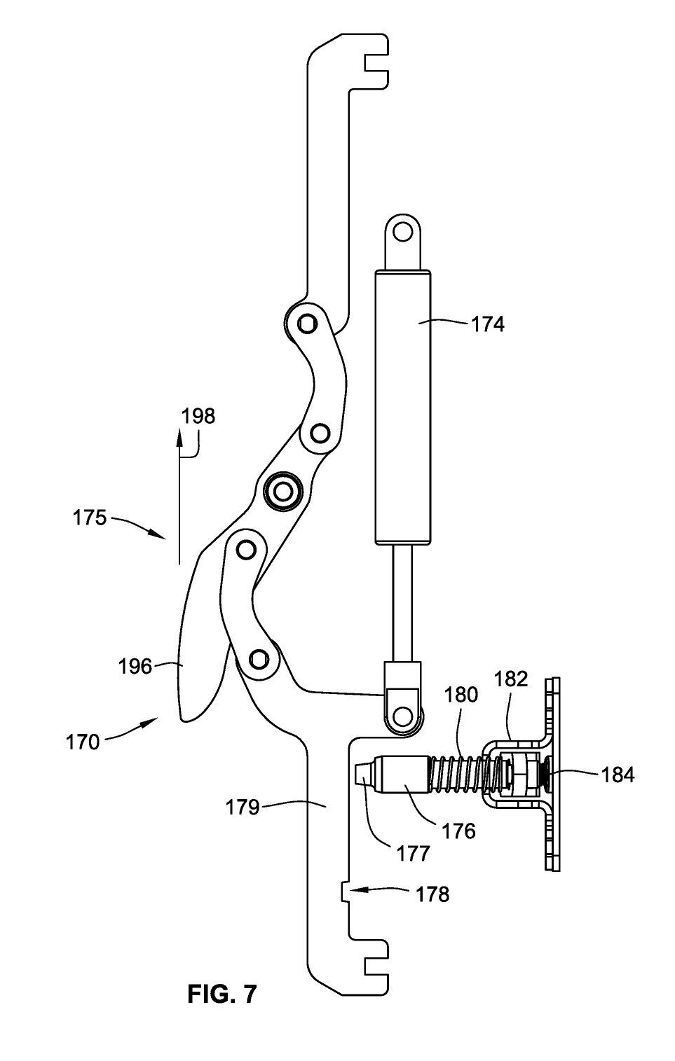

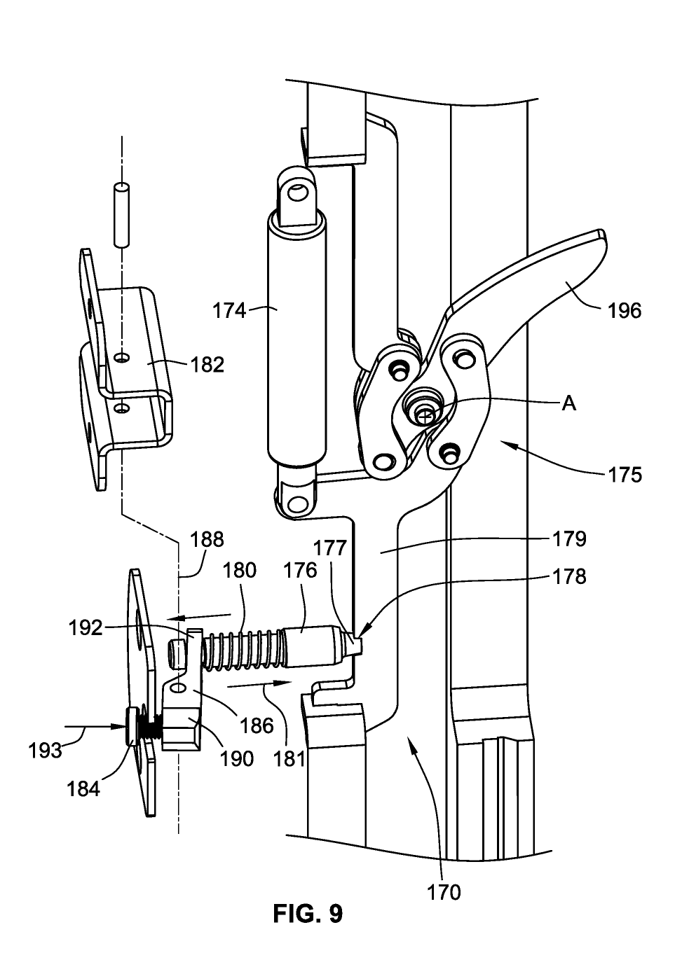

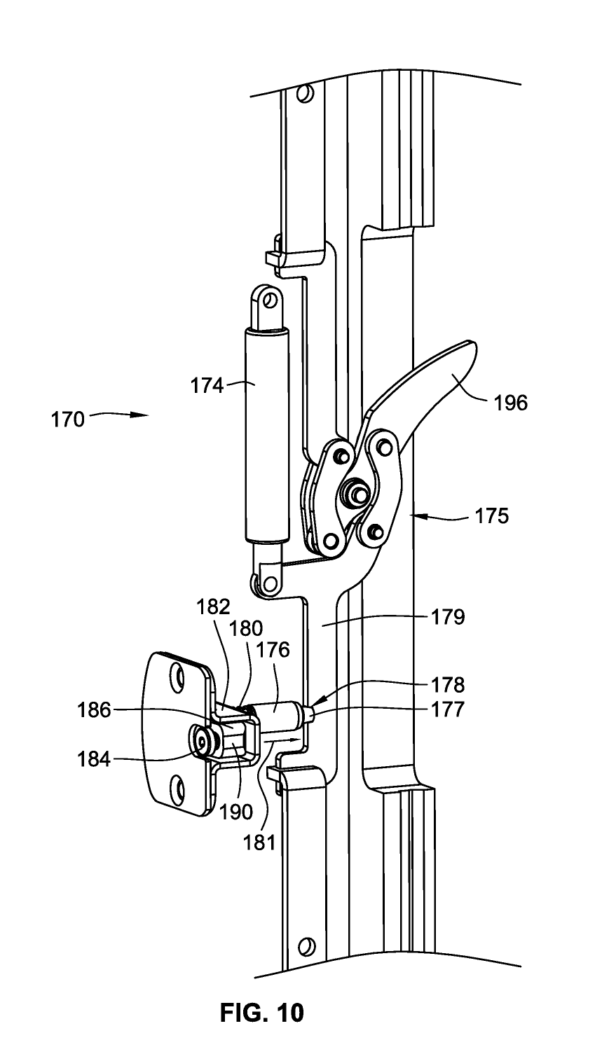

With additional reference to FIGS. 9-12, the actuation arrangement includes an engagement catch 176 which is actuatable between an engaged state (e.g. FIGS. 9 and 10) and a released state (FIGS. 7, 11 and 12). In the engaged state, the engagement catch 176 operably engages shootbolts 172 when the shootbolts 172 are in the retracted state to hold the shootbolts 172 in the retracted state. In this embodiment, “operably engages” is performed by indirect engagement. More particularly the engagement catch 176 engages a portion of the linkage 175 coupled between compressed gas cylinder 174 and shootbolts 172.

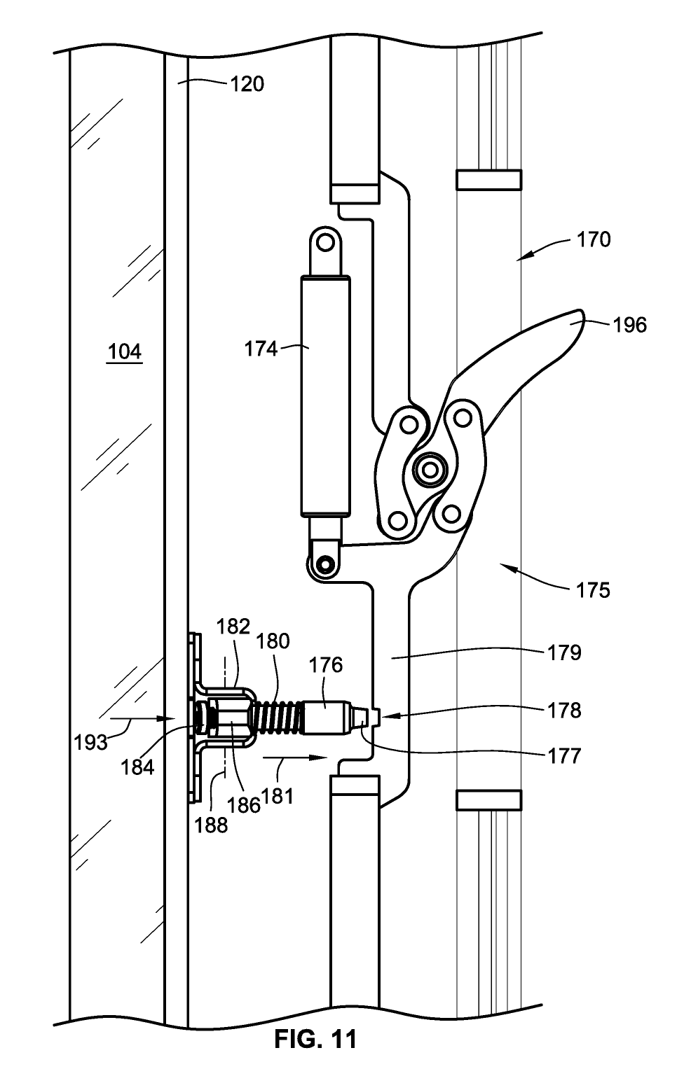

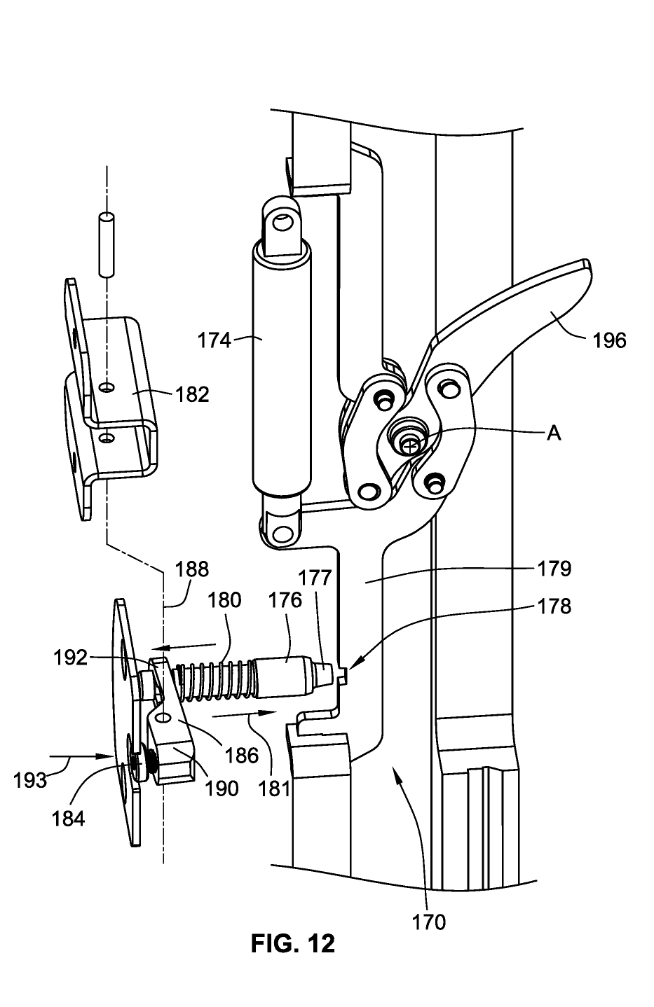

The engagement catch 176 in this embodiment is a pin 177 that is received in a notch 178 formed in linkage member 179 of linkage 175 (see e.g. FIGS. 11 and 12 for ease of clarity). A biasing mechanism in the form of a coil spring 180 is compressed between a carrier member 182 and the engagement catch 176 to bias the engagement catch towards the engaged state, e.g. towards linkage member 179, illustrated by arrow 181.

When the engagement catch 176 is in the released state and disengaged from notch 178, the compressed gas cylinder 174 drives the shootbolts 172 to their extended state. FIGS. 11 and 12 show the engagement catch 176 just after it has been removed from notch 178 while FIGS. 5-8 illustrate the automatic latch arrangement 170 after the compressed gas cylinder 174 has driven the shootbolts 172 to the extended state.

The automatic latch arrangement 170 is automatic in that the shootbolts 172 will be automatically extended as the first and second panels 102, 104 are being transitioned towards the first orientation where the first and second panels 102, 104 are coplanar with one another from the second orientation where the first and second panels 102, 104 are folded relative to one another.

To provide for the automatic operation, the automatic latch arrangement 170 includes a contact 184 that is operably coupled to the engagement catch 176. The contact 184 is engageable with the second panel 104 as the first and second panels 102, 104 transition to the first orientation (co-planar) from the second orientation (folded) to drive the engagement catch 176 from the engaged state to the released state.

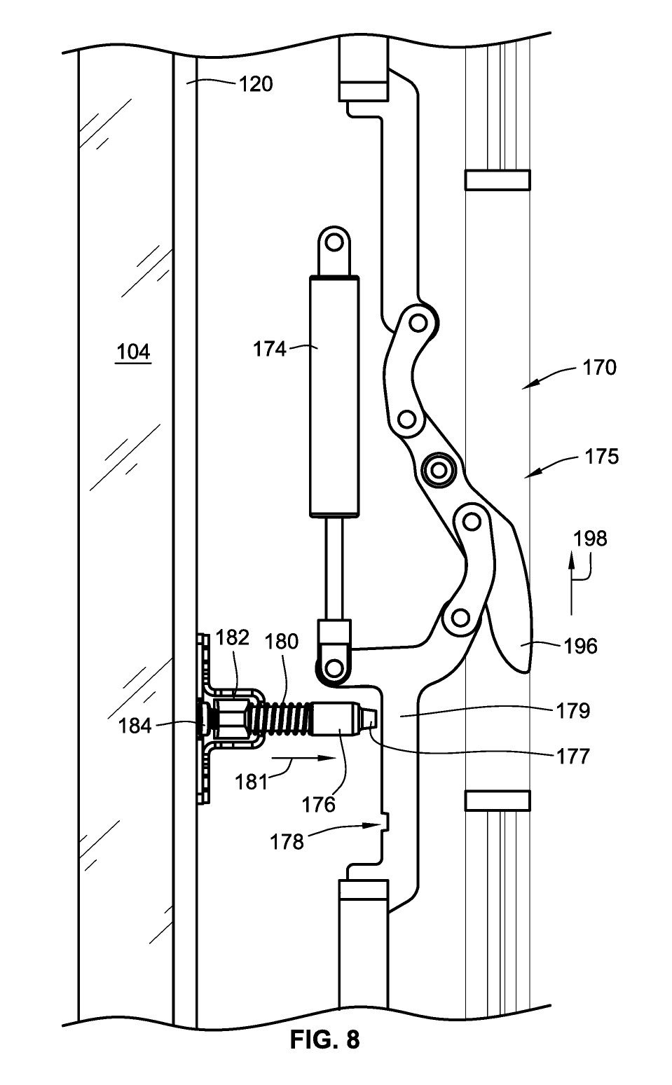

With reference to FIGS. 9 and 11, in the illustrated embodiment, the contact 184 is carried by a pivoting linkage 186 that is pivotably mounted to carriage member 182 for pivotal motion about axis 188 by a pin. As the second panel 104 pushes contact 184 (illustrated by arrow 193 in FIGS. 5, 9, 11 and 12 and illustrated by stile 120 in FIG. 8) at one end 190 of pivoting linkage 186, the pivoting linkage 186 pivots and the opposed end 192 of pivoting linkage 186 pulls engagement catch 176 out of notch 178. End 192 includes a slot therein which engages a head portion of engagement catch 176. This pulling action of engagement catch 176 compresses coil spring 180. With the engagement catch 176 disengaged from notch 178, compressed gas cylinder 174 extends and operably drives shootbolts 172 to the extended state from the retracted state.

In the illustrated embodiment, the contact 184 is adjustably attached to pivoting linkage 186 so that the amount at which the contact extends outward beyond the second stile 114 can be adjusted to adjust the orientation of the first and second panels 102, 104 at which the contact 184 is engaged by the third stile 120. In this embodiment, the contact 184 is simply threadedly attached to pivoting linkage 186 such that adjustment can simply be done by rotating the contact 184 in either direction depending on the adjustment that is needed.

Again, the shootbolts 172, when actuated into the extended state, engage tracks 150, 151 to prevent motion of the first and second panels 102, 104. Due to the configuration of the tracks 150, 151 and particularly the inclusion of grooves 152, 153, the shootbolts 172 are preferably not actuated too early as the panels 102, 104 transition towards the first orientation from the second orientation or the shootbolts 172 will undesirably engage grooves 152, 153 which can potentially damage the shootbolts 172, the tracks 150, 151 (e.g. esthetically or functionally) or even one or more of the panels. Further, yet, the shootbolts 172 are desirably prevented from actuating such that they could damage other parts of the door way or window opening such as adjacent flooring or trim that may be above or around the frame 110.

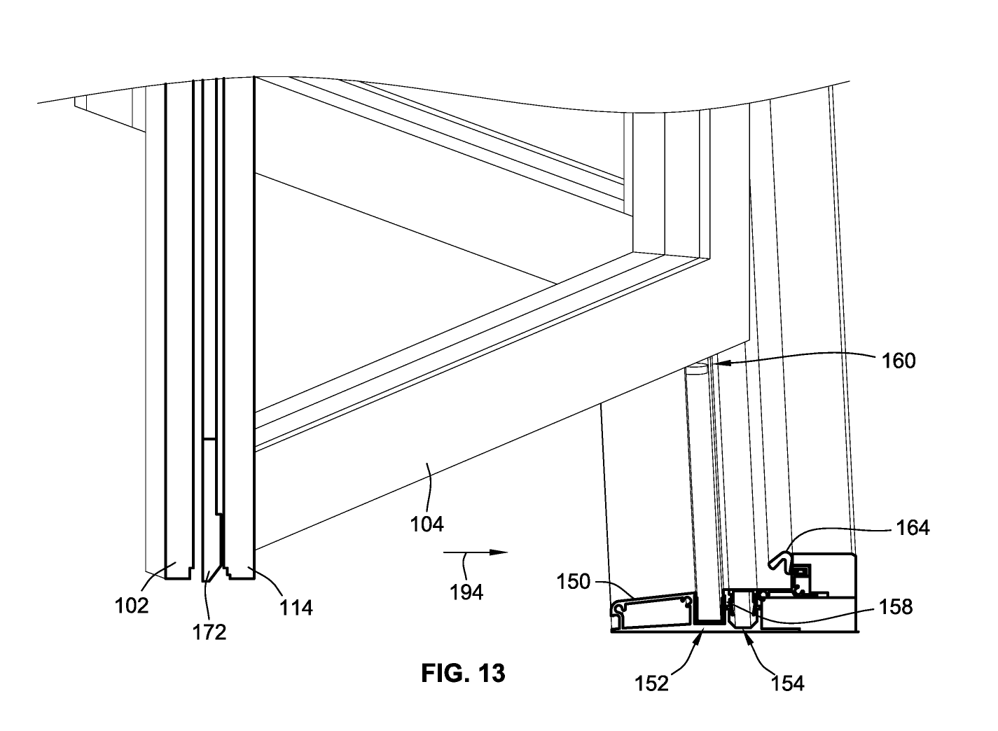

As such, in some embodiments, the contact 184 and the second panel 104 are configured such that the engagement catch 176 will be driven into the released state only when the shootbolts 172 are overlapped in part with the tracks 150, 151. This can limit damage to other surrounding components. More preferably, as the shootbolts 172 are designed to engage grooves 153, 155 to secure the panels 102, 104, the contact 184 and the second panel 104 are configured such that the engagement catch 176 will be driven into the released state only when the shootbolts 172 are overlapped in part with the grooves 153, 155. This can prevent damage to other components of the door assembly such as the tracks 150, 151 or shootbolts 172. Further, it is desirable that the engagement catch will be driven into the released state only when at least a portion of the shootbolts 172 have traveled completely past the first grooves 152, 153, in a direction illustrated by arrow 194 in FIG. 13, as the first and second panels 102, 104 are transitioning from the second orientation to the first orientation. In such an arrangement, this will prevent the shootbolts 172 from being extended between the opposed walls that define the first grooves 152, 153, which would result in premature latching of the first and second panels 102, 104. In this situation, the shootbolts 172 will contact walls 158, 159 and not fully extend. In addition to damage to the door assembly, this could prevent the panels 102, 104 from properly seating against weather stripping or providing a tight closure.

The actuation mechanism, e.g. compressed gas cylinder 174, the contact 184 and second panel 104 as well as linkage 175 may be configured such that if the panels 102, 104 move at a predetermined rate toward the first orientation, that the shootbolts 172 may be initially actuated with the shootbolts 172 overlapped with grooves 152, 153. However, the rate at which the shootbolts 172 are actuated is slow enough that the shootbolts 172 will not extend into grooves 152, 153.

While the automatic latch assembly 170 automatically actuates the shootbolts 172, the illustrated embodiment requires manually releasing the shootbolts 172 from the tracks 150, 151. A handle 196 (see e.g. FIGS. 7 and 8) is operably coupled to shootbolts 172. The handle 196 has a released state and an engaged state. The handle 196 is manually actuatable from the engaged state to the released state to transition the shootbolts 172 from the extended state to the retracted state. The handle 196 is shown in the engaged state in FIGS. 7 and 8. The handle 196 is a linkage member that forms part of linkage 175.

To manually reset the automatic latch assembly 170, the user would push on handle 196 in a direction illustrated by arrow 198 in FIG. 7. This would cause rotation of the linkage 175 and retract the shootbolts 172. As the panels 102, 104 are transitioned to a folded state, e.g. moved from the first orientation towards the second orientation the contact 184 will disengage third stile 120 and the engagement catch 176 will engage notch 178. This will maintain the shootbolts 172 in the retracted state.

It should be noted that while cover members 156 are present in groove 154, there are gaps formed between adjacent cover members 156 or openings through individual cover members 156 to permit the corresponding shootbolt 172 to engage groove 154.

The third and fourth panels 106, 108 include a latch arrangement 200 that selectively engages to secure the third and fourth panels 106, 108 in a coplanar orientation. Thus, a user could use one or both of the third and fourth panels 106, 108 without releasing automatic latch assembly 170 and folding the first and second panels 102, 104.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A door or window apparatus comprising:
a first track having a longitudinal first groove extending lengthwise along a longitudinal axis;
a first panel having spaced apart first and second sides;
a second panel having spaced apart third and fourth sides, the second side hingedly attached to the third side, the first and second panels pivotable between a first orientation in which the first and second panels are coplanar and parallel to the longitudinal axis and a second orientation in which the first and second panels are folded relative to one another and are non-parallel to the longitudinal axis;
a mounting arrangement pivotably securing the first and fourth sides adjacent the longitudinal axis, the mounting arrangement including a first guide mounted adjacent one of the first and fourth sides slidably guided by the first track to allow the first and fourth sides to move relative to one another along the longitudinal axis;
an automatic latch arrangement mounted to the first panel proximate the second side, the automatic latch arrangement including:
a first shootbolt that is selectably retractable and extendable relative to the first panel between an extended state and a retracted state, the first shootbolt operably extending into the first track in the extended state when the first and second panels are in the first orientation preventing the first and second panels from pivoting from the first orientation;
an actuation arrangement including:
a biasing mechanism operably coupled to the first shootbolt biasing the shootbolt from the retracted state toward the extended state;
an engagement catch actuatable between an engaged state and a released state, in the engaged state, the engagement catch operably engages the shootbolt when the shootbolt is in the retracted state to hold the shootbolt in the retracted state, in the released state, the engagement catch operably disengages from the shootbolt allowing the biasing mechanism to drive the shootbolt from the retracted state to the extended state; and
a contact operably coupled to the engagement catch, the contact engageable with the second panel as the first and second panels transition to the first orientation from the second orientation to drive the engagement catch from the engaged state to the released state.

2. The apparatus of claim 1, wherein the contact and second panel are configured such that the engagement catch will be driven into the released state only when the shootbolt is overlapped at least in part with the first track.

3. The apparatus of claim 1, wherein:
the first guide slides, at least in part, within the first groove;
the contact and second panel are configured such that the engagement catch will be driven into the released state only when at least a portion of the shootbolt has traveled completely past the first groove as the first and second panels are transitioning from the second orientation to the first orientation.

4. The apparatus of claim 3, wherein:
the track has opposed walls with the first groove formed between the opposed walls; and
the contact and second panel are configured such that the engagement catch will be driven into the released state only when the shootbolt will not extend between the opposed walls when the engagement catch is in the released state.

5. The apparatus of claim 1, wherein the second and third sides move transverse to the longitudinal axis as the first and fourth sides move toward or away from one another along the longitudinal axis.

6. The apparatus of claim 1, further comprising a handle operably coupled to the shootbolt, the handle having a released state and an engaged state, the handle manually actuatable from the engaged state to the released state to transition the shootbolt from the extended state to the retracted state.

7. The apparatus of claim 1, wherein the actuation arrangement further includes a pivoting linkage pivoting about a pivot axis, the contact connected to the pivoting linkage proximate a first end of the pivoting linkage and the engagement catch connected to the pivoting linkage proximate a second end opposite the first end with the pivot axis being positioned between the first and second ends.

8. The apparatus of claim 1, wherein the contact is adjustably mounted to the pivoting linkage to adjust a position at which the contact will engage the second panel as the first and second panels transition towards the first orientation from the second orientation.

9. The apparatus of claim 8, wherein the contact is threadably mounted to the pivoting linkage.

10. The apparatus of claim 1, wherein the actuation arrangement includes a second biasing mechanism acting on the engagement catch biasing the engagement catch from the released state towards the engaged state, the second panel acting against the second biasing mechanism when driving the engagement catch from the engaged state to the released state.

11. The apparatus of claim 1, wherein the automatic latch arrangement is configured such that as the first and second panels transition from the second orientation to the first orientation the shootbolt will not be driven from the retracted state to the extended state within the first groove.

12. The apparatus of claim 11, wherein the biasing mechanism is a compressed gas cylinder.

13. The apparatus of claim 1, wherein the track includes a second groove that is positioned adjacent to and parallel with the first groove, the shootbolt extends into the second groove in the extended state.

14. The apparatus of claim 13, wherein:
a longitudinal wall of the first track separates the first groove from the second groove; and
the contact and second panel are configured such that the engagement catch will be driven into the released state only when the shootbolt is overlapped at least in part with the second groove of the first track.

15. The apparatus of claim 1, wherein a linkage is connected between the biasing mechanism and the shootbolt, and wherein the engagement catch directly engages the linkage to operably engage the shootbolt in the engaged state.

16. The apparatus of claim 1, wherein the first side is pivotally secured by the mounting arrangement at a fixed location along the longitudinal axis and the first guide is attached to the second panel proximate the fourth side.

17. The apparatus of claim 16, further comprising:
a third panel having spaced apart fifth and sixth sides, the fifth side hingedly attached to the fourth side of the second panel;
a fourth panel having spaced apart seventh and eighth sides, the eighth side pivotally attached to the mounting arrangement at a fixed location along the longitudinal axis;
a latch arrangement between the third and fourth panels selectively securing the third and fourth panels in a coplanar orientation when the first, second, third and fourth panels are in a coplanar orientation with the sixth and seventh sides adjacent one another.

18. The apparatus of claim 1, wherein:
the first panel includes a first vertical member, the automatic latch arrangement being mounted in the first vertical member, the first vertical member having an inner surface facing the first side of the first panel and an outer surface facing away from the first side of the first panel and providing the second side of the first panel; and
the contact extending through the outer surface of the first vertical member.

19. The apparatus of claim 1, further comprising a second automatic latch arrangement mounted to the second panel proximate the third side, the second automatic latch arrangement being identical to the automatic latch arrangement mounted to the first panel but having a contact that cooperates with the second side of the first panel.

20. The apparatus of claim 13, wherein:
the shootbolt travels past the first groove as the first and second panels transition from the second orientation to the first orientation;
the contact and second panel are configured such that the engagement catch will be driven into the released state only when the shootbolt is sufficiently past the first groove that the shootbolt will not be driven into the first groove.

21. A method of latching a door or window apparatus according to claim 1 comprising:
transitioning the first and second panels from the second orientation to the first orientation;
preventing pivoting of the first and second panels from the first orientation to the second orientation by extending the shootbolt to the extended state into the first track, extending the shootbolt includes:
driving the shootbolt to the extended state with the biasing mechanism, which includes:
actuating the engagement catch from the engaged state to the released state by engaging the contact with the second panel as the first and second panels transition to the first orientation.

22. The method of claim 21, wherein actuating the engagement catch occurs when the shootbolt is overlapped at least in part with the first track.

23. The method of claim 21, wherein actuating the engagement catch occurs after at least a portion of the shootbolt has traveled completely past the first groove as the first and second panels are transitioning from the second orientation to the first orientation.

24. The method of claim 21, wherein the door or window apparatus further includes a handle operably coupled to the shootbolt, the handle having a released state and an engaged state, the method further comprising:
transitioning shootbolt from the extended state to the retracted state by actuating the handle from the engaged state to the released state.

25. The method of claim 21, further comprising adjusting a position of the contact relative to the first panel so as to adjust the relative position of the first and second panels when the second panel and the contact will engage as the first and second panels transition towards the first orientation from the second orientation.

26. The method of claim 21, wherein:
the track includes a second groove that is positioned adjacent to and parallel with the first groove, a longitudinal wall of the first track separates the first groove from the second groove; and
the step of driving the shoot bolt includes extending the shootbolt into the second groove in the extended state.

27. The method of claim 26, wherein the contact and second panel are configured such that the engagement catch will be driven into the released state only when the shootbolt is overlapped at least in part with the second groove of the first track.

28. The method of claim 21, wherein:
the shootbolt travels past the first groove as the first and second panels transition from the second orientation to the first orientation; and
wherein the contact and second panel are configured such that the engagement catch will be driven into the released state only when the shootbolt is sufficiently past the first groove that the shootbolt will not be driven into the first groove.

29. An automatic latch arrangement for use with a door or window apparatus, the door or window apparatus having a first track having a longitudinal first groove extending lengthwise along a longitudinal axis, a first panel having spaced apart first and second sides; a second panel having spaced apart third and fourth sides, the second side hingedly attached to the third side, the first and second panels pivotable between a first orientation in which the first and second panels are coplanar and parallel to the longitudinal axis and a second orientation in which the first and second panels are folded relative to one another and are non-parallel to the longitudinal axis, a mounting arrangement pivotably securing the first and fourth sides adjacent the longitudinal axis, the mounting arrangement including a first guide mounted adjacent one of the first and fourth sides slidably guided by the first track to allow the first and fourth sides to move relative to one another along the longitudinal axis, the automatic latch arrangement comprising:
a first shootbolt that is selectably retractable and extendable relative to the first panel between an extended state and a retracted state, the first shootbolt operably extending into the first track in the extended state when the first and second panels are in the first orientation preventing the first and second panels from pivoting from the first orientation;
an actuation arrangement including:
a biasing mechanism operably coupled to the first shootbolt biasing the shootbolt from the retracted state toward the extended state;
an engagement catch actuatable between an engaged state and a released state, in the engaged state, the engagement catch operably engages the shootbolt when the shootbolt is in the retracted state to hold the shootbolt in the retracted state, in the released state, the engagement catch operably disengages from the shootbolt allowing the biasing mechanism to drive the shootbolt from the retracted state to the extended state; and
a contact operably coupled to the engagement catch, the contact engageable with the second panel as the first and second panels transition to the first orientation from the second orientation to drive the engagement catch from the engaged state to the released state; and
the first shootbolt and actuation arrangement mountable to the first panel proximate the second side.
